(19) United States
(12) Patent Application Publication
(10) Pub. No.: US 2007/0237925 A1
(43) Pub. Date: Oct. 11, 2007

(54) Radiation cured coatings

(76) Inventors: Scott Richard Castle, Lexington, KY (US); Sudha Chidambaram Chopra, Lexington, KY (US); Marc Cousoulis, Versailles, KY (US); Gary Allen Denton, Lexington, KY (US); Bhaskar Gopalanarayanan, Lexington, KY (US); Bart Allan Mansdorf, Lexington, KY (US); Vernon Wayne Ulrich, Grove City, PA (US); Mark Stephen Weisman JR., Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/400,494

(22) Filed: Apr. 7, 2006

(51) Int. Cl. B05D 3/10; B05D 3/12

(52) U.S. Cl. 428/141; 427/333; 427/355

(57) ABSTRACT

A radiation cured coating may be applied to a device in an image forming apparatus. The coating may be textured using an embossing method wherein radiation is passed through an embossing device to react a chemical component of the coating. The coating may also be textured by providing multiple coating layers exhibiting differential shrinkage upon exposure to radiation and reacting.

### FIELD OF INVENTION

The present invention relates to radiation cured coatings which may be used in an image forming apparatus. The image forming apparatus may include inkjet printers, electrophotographic printers, copiers, fax machines, all-in-one devices and multifunctional devices.

### BACKGROUND

Many devices used in image forming apparatus may utilize coatings for various purposes. These purposes may include modification of electrical, physical and chemical properties such as resistivity, roughness, or surface energy. The devices upon which the coatings may be applied within an image forming apparatus may include photo-conductive devices and non-photoconductive rollers such as developer rollers, doctor blades, etc.

### SUMMARY

An aspect of the present invention relates to a device for an image forming apparatus comprising a radiation cured coating wherein a texture may be formed in the coating prior to or during radiation curing. Another aspect of the present invention relates to a device for an image forming apparatus comprising a first and second layer of a radiation cured chemical component wherein the first and second layers have a differential shrinkage in volume upon exposure to radiation.

A further aspect of the present invention relates to a method for texturing a radiation curable coating for an image forming apparatus employing an embossing device. The method includes coating a substrate with a chemical component, exposing the chemical component to radiation wherein the radiation passes through the embossing device and embossing the chemical component while it may be curing. The method may also comprise coating a substrate with a first chemical component, having a first volumetric shrinkage VS₁ when reacting. The first chemical component may be coated with a second chemical component having a second volumetric shrinkage VS₂ when reacting, wherein VS₁≠VS₂. The first and second chemical components may therefore interact and form a textured surface.

### BRIEF DESCRIPTION OF DRAWINGS

The detailed description below may be better understood with reference to the accompanying figures which are provided for illustrative purposes and are not to be considered as limiting any aspect of the invention.

FIG. 1 illustrates one exemplary technique for texturing a surface, such as a roller surface.

FIG. 2 illustrates another exemplary technique for texturing a surface of a component containing radiation cured resin.

FIG. 3 illustrates an exemplary viscosity v. time graph for a chemical component undergoing radiation curing.

### DETAILED DESCRIPTION

The present invention relates to the use of radiation cured coatings that may be used in a device within an image forming apparatus. The device may also be used within a printer cartridge (e.g. toner cartridge). The device may therefore supply a substrate and substrate surface which may be coated. The radiation cured coatings, as referred to herein, may be understood as coatings that are sourced from a chemical component which may increase in viscosity and/or molecular weight though a polymerization and/or cross-linking reaction. The chemical component may therefore amount to monomers and/or oligomers which may react (cure) and undergo initiation by a radiation source.

The coatings may be applied to devices within an image forming apparatus such as doctor blades, developer rollers, etc. The devices may also be photoconductive or non-photoconductive components. The coatings may also be applied to devices and serve as an adhesive. The coating may include 100% (wt.) reactive chemical component or it may include solvents or water as a diluent. Furthermore, textures may be incorporated into the coatings, which texture may be incorporated prior to or during cure (polymerization). The coatings may also contain fillers which may affect initial component (e.g. monomer) viscosity as well as viscosity build-up prior to gel or solidification. In addition the fillers may also influence ultimate texture at the surface of the cured resin. Fillers may include particulate, metallic, ceramic, ionic or even polymeric type materials.

The chemical component herein may experience various types of reactive polymerization mechanisms, when initiated, such as free radical or ionic type polymerization. The chemical components may include acrylate, methacrylate, epoxide, vinyl ether, or vinyl functionality. Moreover, the functionality of the monomers herein may be adjusted to provide for higher relative viscosity build-up or molecular weight over relatively shorter periods of time, i.e., shorter times for overall cure. For example, prior to exposure or reacting, the coating may have an initial viscosity of about 1.0 to 100,000 centipoise, including all values and increments therebetween.

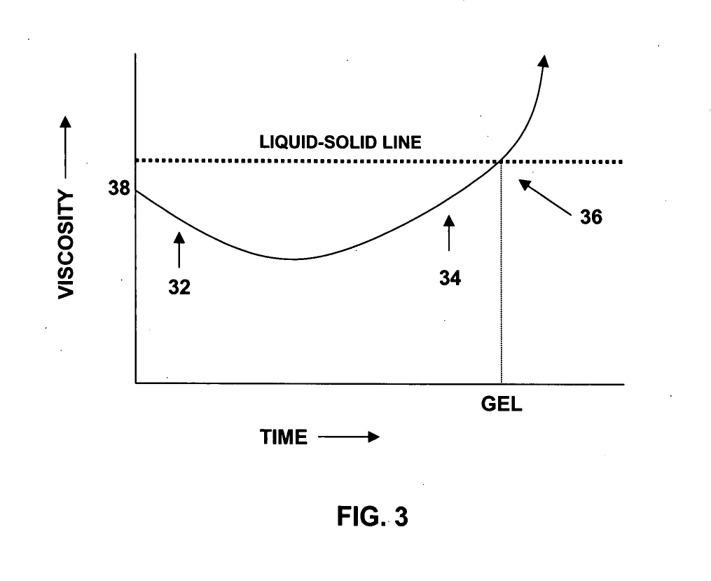

Once exposed however, the viscosity of the coating may increase along with molecular weight and the viscosity ultimately increases as the material proceeds to solidify. As illustrated in FIG. 3, and as noted above, at 38 one may begin with a chemical component that has a viscosity of about 1.0-100,000 centipoise. Upon exposure to radiation, the viscosity may show an initial drop at 32 due to the exothermic nature of the polymerization (curing) reaction. However, at a certain point, the effect of the exotherm may be overcome by the build-up in molecular weight and viscosity that occurs, which is shown generally at 34. As the reaction proceeds, the build-up in molecular weight and viscosity approaches a region 36 where the reaction mixture may cross a liquid-solid line, and the reaction mixture solidifies. Such region 36 may also be termed a “gel” point, which may be understood as that point in the reaction where crosslinking has developed to such levels that the reaction mixture “gels”, approaches solidification, and may also be observed as being generally insoluble in most solvents. Accordingly, prior to crossing the liquid-solid line, the chemical component undergoing radiation curing herein may be texturized by, e.g., embossing the surface of the coating (e.g., pressing a pattern into the coating surface). Therefore, one may texturize the coating prior to or during radiation curing, and prior to the point in which the viscosity crosses a liquid-solid line.

The initiators that may be used may be those suitable for radiation polymerization and may include, for example, photo-initiators, etc. The initiators may therefore include any compound that is capable of absorbing light or radiation and providing a reactive site, such as a free-radical, cationic or anionic source.

Radiation sources may include for example, ultraviolet light, visible light, a laser source, or an electron beam. For example, ultraviolet (UV) light may be directed at the coating to be cured. Upon exposure the UV light may interact with the chemical components of the polymer coating material causing polymerization and/or crosslinking. Furthermore, process variables that may be varied in the use of ultraviolet radiation include, for example, frequency range, power level and exposure time.

In electron beam radiation, the polymer material coating may be bombarded with high-energy electrons. The polymer materials may undergo a number of reactions that may include, for example, polymerization and/or crosslinking as well as chain scission and/or molecular rearrangement. Process variables that may again be varied include power and exposure time.

Radiation exposure may occur in an inert atmosphere employing inert gases such as nitrogen, argon, or other non-reactive gasses. The radiation may also be manipulated or altered so as to direct, focus or disperse the radiation emanating from the radiation source. This may be accomplished via devices such as reflective devices including optical mirrors, lenses, dichroic filters and electromagnetic lenses.

The chemical components may also be applied to a substrate as a coating by a number of processes such as spray, dip, flow, curtain, knife-over-roll, gravure, meyer and reverse rod, slot die, spin casting, etc. Some processes may be enhanced by electrostatic control or ultrasonic droplet generation in a given coating method. The coating may be applied at about 1 to 10,000 microns in thickness, including all values and increments therebetween. The coating may be formed from a build-up of one or more layers. The layers may be applied, e.g., while an underlying layer is reacting and in a viscous liquid state or when an underlying layer has reached a gel point or solidified.

The radiation cured coating may also be textured. Texturing or a textured surface may be understood herein as the development of a surface wherein the surface profile is not substantially uniform. Stated another way, the surface may have variations, a surface roughness or even a pattern formed therein. The surface may have, e.g., projections extending from the surface or indentations.

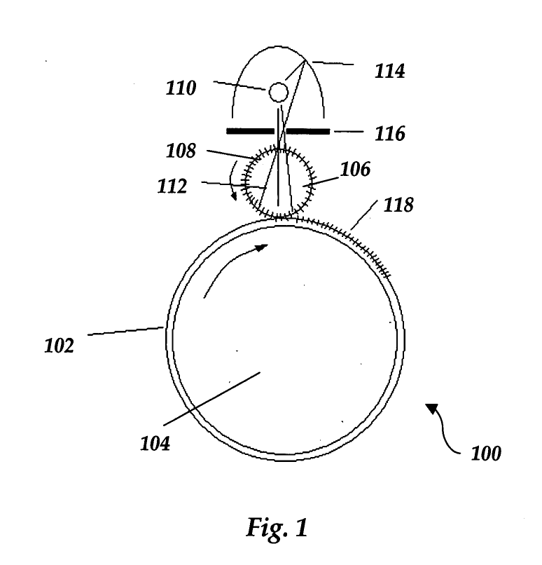

An exemplary process which may be used for texturing the coating is illustrated in FIG. 1. A substrate 100, such as a developer roll, may be supplied with a coating 102 formed on the outer surface of the roll 104. A roller 106 including a textured surface 108 may be applied to the coating, embossing the coating 102. The embossing device may be applied to the coating in the range of 0 to 100 pounds per square inch (psi), including all increments and ranges therebetween, such as 10 pounds per square inch, 50 pounds per square inch, etc.

It should be appreciated that while a roller is illustrated and described other embossing devices, such as belts, stamps, screens or plates may be used. It should also be appreciated that the embossing device may be translucent, semi-transparent or transparent to the radiation employed, such as visible, UV, infrared or high energy electrons. For example, greater than 50% of the radiation may pass through the embossing device, including all increments or values therein, i.e., 70%, 90%, etc. Furthermore, the embossing device may not be immediately applied in a contacting relationship with the coating or with sufficient pressure to emboss the coating until a desired increase in viscosity or increase in molecular weight has been reached. See again, FIG. 3.

A radiation source such as a UV lamp 110, electron beam emitter, visible light, a laser source, or an infrared lamp, may be provided which may utilize, for example, one or a combination of mirrors such as the elliptical mirror illustrated 114, lenses such as the opaque shield including a slit 116, dichroic filters, or an electromagnetic lens to deflect, filter or focus the radiation, such as UV light 112 through the embossing device 106 and onto the coating 102. The coating 102, exposed to the UV light may then increase viscosity or molecular weight through polymerization or crosslinking and include a texture 118 formed thereon.

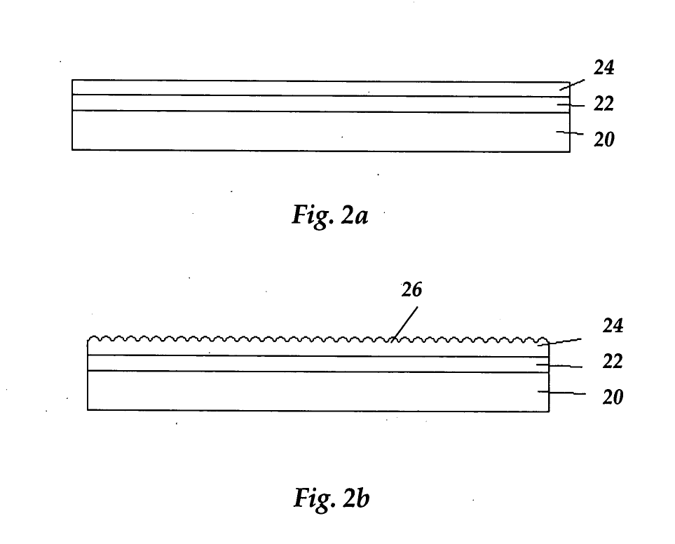

Another exemplary process which may be used for texturing the coating is illustrated in FIGS. 2a and 2b. A substrate 20 may be provided upon which two or more coating layers may be applied. A first coating layer 22, including a first chemical component, may be applied to the substrate 20. A second coating layer 24, including a second chemical component, may be applied to the first coating layer 22. Where the second coating layer may be a final coating layer, the second coating layer may provide a surface.

The first coating layer 22 may have a higher shrinkage during reaction (cure) than the second coating layer 24. This may be a consequence of the feature that e.g., monomers, upon polymerization or crosslinking, may typically reduce in volume relative to the solid (polymeric) material that is formed. Accordingly, upon exposure to radiation, the coatings may increase in viscosity via polymerization or crosslinking, and the differential shrinkage between the two coating layers may create a texture 26 in the second coating layer, as illustrated in FIG. 2b. For example, the first layer may have a volumetric shrinkage (VS₁) that is about 0.1% to 20% greater than the volumetric shrinkage of the second layer (VS₂), including all values and increments therebetween, such as 1%, 10%, etc. It should also be appreciated that the second layer (VS₂) may have a volumetric shrinkage that is about 0.1% to 20% greater than the volumetric shrinkage of the first layer (VS₁), including all values and increments therebetween, such as 1%, 10%, etc.

The coatings employed herein may generally exhibit a number of properties. For example, the coating may have a surface energy between 5 and 90 dyne/cm and all increments or values therebetween, including 10 dyne/cm, 20 dyne/cm etc. The coating may have an elongation at break of between 1% to 500% and all increments or values therebetween, including 20%, 90%, etc. The coating may also have a surface roughness of between 0.01 to 10.0 microns Ra including all values and increments therebetween. Ra is measured using a contact profilometer incorporating a stylus such as a TKL-100 from Hommel. This stylus has a radius of 5 microns and maintains contact with the surface to be characterized at a force of 0.5 mN. The stylus is dragged across the surface with a trace length of 4.8 mm using a cutoff length of 0.8 mm. The surface profile is plotted and a mean line is generated. The Ra is the average deviation of the true surface from the theoretical mean surface across the trace length.

Additionally, the coating may exhibit a bulk resistivity of between about 100 ohm-cm and 1×10¹⁵ ohm-cm, including all increments and values therebetween, such as 1×10¹⁴ ohm-cm, 1×10⁵ ohm-cm, etc, and a dielectric constant between about 1 and 15 and any increment or value therebetween.

The foregoing description is provided to illustrate and explain the present invention. However, the description hereinabove should not be considered to limit the scope of the invention set forth in the claims appended here to.

What is claimed is:

1. A device for an image forming apparatus comprising a radiation cured textured coating wherein said texture is formed in said coating prior to or during said radiation curing.

2. The device of claim 1 wherein said coating has a viscosity and said texture is formed in said coating during said radiation curing and prior to solidification.

3. The device of claim 1 wherein said coating includes a chemical component and said component has a viscosity of about 1.0-100,000 centipoise prior to exposure to said radiation.

4. The device of claim 1 wherein said coating has a surface and said surface has a surface roughness of about 0.01-10.0 microns Ra.

5. The device of claim 1 wherein said coating has a bulk resistivity of about 100-1×10¹⁵ ohm-cm.

6. The device of claim 1 wherein said coating has a dielectric constant of about 1.0-15.0.

7. The device of claim 1 located within an image forming apparatus.

8. The device of claim 1 located within a printing cartridge.

9. A device for an image forming apparatus comprising:
a first and second layer of a radiation cured chemical component wherein said first and second layers have a differential shrinkage in volume upon exposure to said radiation.

10. The device of claim 9, wherein one of said layers of chemical components has a surface and said surface comprises a textured surface.

11. The device of claim 9 wherein said differential shrinkage is between about 0.1% and 20%.

12. The device of claim 9 wherein said chemical component has a viscosity of about 1.0-100,000 centipoise prior to exposure to said radiation.

13. The device of claim 9 wherein one of said chemical components has a surface and said surface has a surface roughness of about 0.01-10.0 microns Ra.

14. The device of claim 9 wherein one of said chemical components has a bulk resistivity of about 100-1×10¹⁵ ohm-cm.

15. The device of claim 9 wherein one of said chemical components has a dielectric constant of about 1.0-15.0.

16. The device of claim 9 located within an image forming apparatus.

17. The device of claim 9 located within a printing cartridge.

18. A method of texturing a radiation curable coating employing an embossing device comprising:
coating a substrate with a chemical component;
exposing said chemical component to radiation wherein said radiation passes through said embossing device; and
embossing said chemical component.

19. The method of claim 18 wherein said chemical component upon exposure to radiation reacts and increases in viscosity.

20. The method of claim 19 wherein said step of embossing occurs prior to solidification.

21. The method of claim 18 wherein said chemical component has a viscosity of about 1.0-100,000 centipoise prior to exposure to said radiation.

22. The method of claim 18 wherein said step of embossing occurs during said step of exposing said chemical component to radiation.

23. The method of claim 18 wherein said embossing device transmits greater than about 50% of said radiation to said chemical component.

24. A method of forming a textured coating for an image forming apparatus comprising:
coating a substrate with a first chemical component, having a first volumetric shrinkage (VS₁) when reacting;
coating said first chemical component with a second chemical component having a second volumetric shrinkage (VS₂) when reacting,
wherein VS₁≠VS₂; and
reacting said first and second chemical component and forming a textured surface.

25. The method of claim 24 wherein VS₁ is between about 0.1% and 20% greater than VS₂.
